(19) United States
(12) Patent Application Publication
(10) Pub. No.: US 2019/0116834 A1
(43) Pub. Date: Apr. 25, 2019

(54) MULTI-FLAVORED BEVERAGE

(71) Applicant: SHAKA CORPORATION, North Sioux City, SD (US)

(72) Inventors: Richard Hirschauer, Whitting, IA (US); Larry D. Marting, Sioux City, IA (US)

(21) Appl. No.: 16/229,273

(22) Filed: Dec. 21, 2018

Related U.S. Application Data
(63) Continuation of application No. 14/352,752, filed on Apr. 18, 2014.
(60) Provisional application No. 61/558,702, filed on Nov. 11, 2011.

(51) Int. Cl. A23L 2/56; A23L 27/00; A23L 29/281; A23L 2/38; A23L 2/52; A23L 29/256

(52) U.S. Cl. CPC A23L 2/56; A23L 27/00; A23L 29/256; A23L 2/38; A23L 2/52; A23L 29/284

(57) ABSTRACT

A beverage can include a beverage base and a flavor additive. The flavor additive can be heterogeneously mixed within the beverage base. The flavor additive can include at least a flavoring and a gelling agent, with the gelling agent comprising 2% by weight or less of the flavor additive. The flavor additive can be in a form of at least one of a liquid suspension, a liquid, or a semi-liquid and further can be non-blending with the base beverage. The flavor additive can remain in a stable, separate phase from the beverage base even upon agitation.

### CROSS REFERENCE TO RELATED APPLICATIONS

The present application is a continuation application of U.S. Non-Provisional application Ser. No. 14/352,752, filed Apr. 18, 2014, and entitled MULTI-FLAVORED BEVERAGE. The present application claims the benefit under 35 U.S.C. § 119 of PCT International Application No. PCT/US2012/064297, filed Nov. 9, 2012, and entitled MULTI-FLAVORED BEVERAGE, which claims priority to U.S. Provisional Application No. 61/558,702, filed Nov. 11, 2011, and entitled MULTI-FLAVORED BEVERAGE. The above-mentioned applications are incorporated herein in their entirety.

### BACKGROUND

The present application relates to beverages. In particular, the present application relates to beverages having multiple flavors.

Using current beverage technology, beverages typically employ a blend of flavorings to achieve a homogeneous flavor profile. In such beverages a base is used to which flavorings, sweeteners, and other ingredients are added. The result is a consistent flavor profile for the entire beverage. This means the consumer detects the same flavorings in the same proportions throughout the process of drinking the beverage.

An example of such a beverage is a flavored soda. In sodas, carbonated water may serve as the beverage base to which a blend of flavorings, juices, sweeteners, preservatives, stabilizers, and other ingredients may be added. In a fruit flavored cola, multiple flavorings may be used to provide both a cola flavor and a fruit flavor (such as cherry or citrus). While providing multiple flavors, these flavors are blended and provide a homogeneous flavor profile to the beverage.

### SUMMARY

Some embodiments relate to a flavor additive including a base selected from proteins, gelatin, pectin, alginate, gums, starches, modified starches, oils, food grade petrochemicals, and mixtures thereof. A flavor component is stably distributed in the base. Other embodiments relate to beverages including a beverage base and a heterogeneous flavor additive. The heterogeneous flavor additive may have a flavor base, and a flavoring. The heterogeneous flavor additive at least partially remains in a stable, separate phase from the beverage base. Yet other embodiments relate to a multi flavored beverage including a first phase including a first flavor profile and a second phase, distinct from the first phase. The second phase has a second flavor profile that is perceptably different from the second flavor profile.

### DETAILED DESCRIPTION

It is believed that the consumer experience of drinking a beverage could be enhanced or otherwise improved by providing a beverage having a flavor profile that varies as the beverage is consumed. Further, it would be beneficial to provide a beverage with which the consumer can affect the flavor profile without adding additional flavorings.

A multi-flavored beverage may generally have a water, juice, or dairy base to which other ingredients have been added. These ingredients may include preservatives, sweeteners, stabilizers, carbonation, or other ingredients. Optionally, the base may be flavored with one or more homogeneously blended flavorings. To this base formulation, one or more heterogeneous flavor additives may be added. It should be noted that the term “heterogeneous” is not strictly being applied to the flavor additive itself (which may be homogenous) but rather is used to describe a flavor additive that, when added to a beverage, results in a beverage having a heterogeneous flavor profile.

The heterogeneous flavor additives provide distinct flavor profiles that may be physically separated from the base and from other heterogeneous flavor additives in the same beverage. A key to consumer acceptability of such a system is a consistent mouth feel across the beverage. This allows for a heterogeneous flavor profile while maintaining a consistent mouth feel for the consumer as the beverage is consumed.

Flavor separations and a comfortable mouth feel may be achieved by utilizing several ingredients and methods in the manufacturing process of creating the heterogeneous flavor additives. The heterogeneous flavor additives include, but are not limited to, a base ingredient such as a protein, agar, a gum, and/or any of the following listed ingredients in various amounts and combinations, depending on the type of beverage base the heterogeneous flavor additives will be added into: proteins (e.g., a gelatin), agar, pectin, alginate, gums, starches, modified starches, oils, and/or food grade petrochemicals. The heterogeneous flavor additives may be a liquid, semi-liquid, or a suspension.

The heterogeneous flavor additives may remain at least partially non-congenial with each other and with the beverage base solution by controlling the gel action to limit the gel to a stable viscous solution that has virtually the same texture as the base beverage. So close to the same texture of the base beverage that the burst of flavor will overwhelm any slight texture difference between the beverage base solution and the heterogeneous flavor additive.

Other techniques may be employed in the manufacturing of the heterogeneous flavor additives. For example, the stability of a flavor additive may be improved by micro-encapsulation of one or more of the ingredients. Also, various stabilizers, preservatives, and other ingredients may be used. A specialized container or manufacturing process may also be utilized to assist the long term stability of the heterogeneous flavor additives.

The consumer will be able to adjust the distribution of the separate heterogeneous flavors additives by shaking the beverage container. If the beverage is shaken, stirred, or otherwise agitated a little, the flavor layers will still remain as separate flavors, and will be distributed throughout the beverage in relatively large globules. When drinking the beverage, the consumer will experience relatively large bursts of flavor, and greater variation from sip to sip. For example, separate large bursts of chocolate and separate large bursts of mint in cola. The heterogeneous flavor additives will form relatively large globules. Visually the beverage will look similar to a lava lamp with large globs of heterogeneous flavor additives distributed throughout the beverage.

If the beverage is shaken, stirred, or otherwise agitated, to a greater degree, the heterogeneous flavor additives will still remain as separate flavors and will be distributed more uniformly in smaller globules throughout the beverage. The consumer will then experience smaller flavor bursts more often as the beverage is consumed, and therefore a more homogenous flavor profile. This agitating allows the consumer to control the flavor conditions of his drink to his personal taste without the consumer adding any further ingredients during consumption.

The heterogeneous flavor additives may be pre-dispensed into a beverage by a bottler or other entity. Alternatively, the heterogeneous flavor additives may be integrated with the beverage base at the point of distribution, such as in a beverage fountain. In such cases, the consumer can select a base drink and a number of additional heterogeneous flavor additives that would be co-dispensed with the beverage base. Yet another use of the heterogeneous flavor additives is a flavor packet designed for either single or repeated use, from which a desired amount of a particular heterogeneous flavor additive can be added to a beverage base by the consumer. The heterogeneous flavor packets can also be packaged as an accessory to a beverage and attached to the beverage container.

In some examples, a homogeneous flavor additive was made having a composition of 0.5-1.0 wt % high bloom gelatin in water. This additive was stable as a separate phase in water at ambient temperature down to about 40° F. More specific examples are provided below and are not meant to be limiting but rather, illustrative of the concepts disclosed herein.

### EXAMPLE 1

A heterogeneous flavor mixture was made by adding 15 mL of HERSHEY'S light chocolate syrup to 15 mL of a 1 wt % solution of sodium alginate in water. This was stirred well and brought to a boil. The mixture was removed from the heat and 2 mL of 0.5 wt % calcium chloride (CaCl2) was added drop-wise to the mixture. The exact amount of CaCl2 added may be adjusted so the final mixture has a mouthfeel consistent with the beverage base to which it will be added. The mixture was then brought back to a boil, stirred briefly, packaged and cooled.

The resulting heterogeneous flavor mixture was added to a diet cola and a low-fat milk and observed to maintain separate globules which varied in size. Upon drinking, the beverages were found to have a uniform mouthfeel and the flavor profile varied from sip to sip as various quantities of globules of varying sizes were consumed.

### EXAMPLE 2

A low pH heterogeneous flavor mixture was made using 15 mL HERSHEY'S strawberry syrup in a mixture of 10 mL 4 wt % low bloom gelatin. The mixture was stirred well and 5 mL water was added drop-wise to adjust mouthfeel. The mixture was further stirred and packaged. It is believed that calcium cross-linking of alginate is inhibited by the low pH conditions of many fruit based flavorings.

### EXAMPLE 3

A cherry, heterogeneous flavor additive was made by putting maraschino cherries through a commercially available household juicer. The pulp was filtered and 15 mL of the resulting liquid was added to 5 mL water and 10 mL of 4% low bloom gelatin. The mixture was stirred while cooling.

### EXAMPLE 4

A lime flavored heterogeneous flavor additive was made by adding 15 mL of lime juice (from thawed frozen limeade concentrate) and 15 mL of a 2% low bloom gelatin solution. The mixture was stirred while cooling.

### EXAMPLE 5

An orange-vanilla flavor additive was made by combining 15 mL of CRUSH brand Orange & Vanilla Cream syrup and 15 mL of 1% sodium alginate. The mixture was brought to a boil in a microwave. 1.5 mL of 0.5% CaCl₂ was added dropwise with vigorous stirring. The mixture was stirred while cooling.

### EXAMPLE 6

A banana flavored additive was made by combining 15 mL of GERBER brand banana baby food and 15 mL of 1% sodium alginate. The mixture was brought to a boil in a microwave. 2 mL of 0.5% CaCl₂ was added dropwise with vigorous stirring. The mixture was stirred while cooling.

### EXAMPLE 7

A pear flavored additive was made by combining 15 mL of BEECHNUT pear baby food and 15 mL of 1% sodium alginate. The mixture was brought to a boil in a microwave. 2 mL of 0.5% CaCl₂ was added dropwise with vigorous stirring. The mixture was stirred while cooling.

### EXAMPLE 8

A peanut flavored additive was made by combining 7.5 mL of FAREWAY brand creamy peanut butter, 15 mL of water, and 15 mL of 1% sodium alginate. The mixture was brought to a boil in a microwave. 1 mL of 0.5% CaCl₂ was added dropwise with vigorous stirring. The mixture was stirred while cooling.

### EXAMPLE 9

An almond flavored additive was made by combining 7.5 mL of SOLO brand almond paste, 15 mL of water, and 15 mL of 1% sodium alginate. The mixture was brought to a boil in a microwave. 1.5 mL of 0.5% CaCl₂ was added dropwise with vigorous stirring. The mixture was stirred while cooling.

### EXAMPLE 10

A carrots flavored additive was made by combining 15 mL of BEECHNUT carrots baby food and 15 mL of 1% sodium alginate. The mixture was brought to a boil in a microwave. 2 mL of 0.5% CaCl₂ was added dropwise with vigorous stirring. The mixture was stirred while cooling.

### EXAMPLE 11

A green beans flavored additive was made by combining 15 mL of GERBER brand green beans baby food and 15 mL of 1% sodium alginate. The mixture was brought to a boil in a microwave. 2 mL of 0.5% CaCl₂ was added dropwise with vigorous stirring. The mixture was stirred while cooling.

### EXAMPLE 12

A green peas flavored additive was made by combining 15 mL of BEECHNUT green peas baby food and 15 mL of 1% sodium alginate. The mixture was brought to a boil in a microwave. 2 mL of 0.5% CaCl₂ was added dropwise with vigorous stirring. The mixture was stirred while cooling.

All of the above were found to be stable in chilled or room temperature beverages, and many are stable at temperatures of up to about 140 F. Accordingly, a wide variety of food flavorings may be made to form heterogeneous flavor additives having an acceptable mouthfeel. A variety of beverage applications can be envisioned including, vegetable or fruit drinks including individual vegetable and/or fruit phases in a beverage base such as juice.

Based on the foregoing examples and numerous other experiments, it was determined that a total concentration of 0.5-2 wt. % low bloom gelatin in the final heterogeneous mixture would often result in a mouthfeel consistent with typical beverages at typical consumption temperatures. In particular, 1-1.4 wt. % concentrations produced favorable results. High bloom gelatin may also be used, albeit in lower concentrations. Typically, 0.5-1 wt. % high bloom gelatin resulted in satisfactory results, and particularly good results being found with concentrations between 0.6-0.8 wt. %. In particular, high bloom concentrations of 0.7+/−0.05 wt. % of high bloom gelatin were favored in many applications.

It was also found, that in flavor systems in which calcium cross-linking of alginate is not inhibited, a total concentration of 0.3-1.5 wt. % sodium alginate would result in a satisfactory mouthfeel and a stable, heterogeneous flavor additive. In particular, concentrations of about 0.5-1 wt. % appeared to work well with concentrations of about 0.5+/−0.05 wt. % resulting in very favorable results. Calcium chloride was typically added in near stoichiometric quantities. Mouthfeel of the heterogeneous flavor additive may be adjusted by adding an amount of CaCl₂ in less than a stoichiometric amount and then increasing the cross-linking of the alginate by increasing the amount of CaCl₂ added to an amount up to the stoichiometric amount.

Other additives may, on their own, or in combination with, but not limited to, protein (e.g., a gelatin), alginate, agar, or each other may provide an acceptable mouthfeel and a stable heterogeneous flavor additive. For example, agar may be particularly well suited, especially for application where temperature stability is a requirement. Such applications may include hot beverages such as hot coffee or hot tea. Another promising additive is ε-polylysine which has been shown to be effective for mitigating of diffusion of a variety of color and flavor additives.

What is claimed is:

1. A beverage mixture comprising:
a base beverage; and
a flavor additive distributed in the base beverage, the flavor additive in a form of at least one of a liquid suspension, a liquid, or a semi-liquid, the flavor additive being a stable, heterogeneous, and physically distinct phase within the beverage, the flavor additive having a mouthfeel consistent with the base beverage, the flavor additive itself being a homogeneous mixture, the flavor additive comprising:
a flavor component; and
a gelling agent mixed within the flavor component, the gelling agent comprising 2%, by weight, or less of the flavor additive.

2. The beverage mixture of claim 1, comprising a plurality of non-blending flavor additives.

3. The beverage mixture of claim 1, wherein at least one of a flavor profile or an appearance of the beverage is configured to be adjusted by manually agitating the beverage.

4. The beverage mixture of claim 3, wherein the flavor additive within the base beverage is configured to remain separately visible even after the beverage mixture is manually agitated.

5. The beverage mixture of claim 1, wherein the gelling agent is comprised of at least one of a protein, gelatin, pectin, alginate, gums, starches, modified starches, oils, food grade petrochemicals, agars, ε-polylysine, and mixtures thereof.

6. The beverage mixture of claim 1, wherein the base beverage is selected from the group consisting of water, sodas, coffees, teas, dairy products, sports drinks, meal replacements, and mixtures thereof.

7. The beverage mixture of claim 1, wherein the flavor additive further comprises calcium chloride.

8. The beverage mixture of claim 1, wherein the flavor additive further comprises a color component.

9. A beverage comprising:
a beverage base; and
a flavor additive heterogeneously mixed within the beverage base, the flavor additive including a flavoring and a gelling agent, the gelling agent comprising 2% by weight or less of the flavor additive, the flavor additive being non-blending with the base beverage;
wherein the flavor additive remains in a stable, separate phase from the beverage base even upon agitation, the flavor additive being in a form of at least one of a liquid suspension, a liquid, or a semi-liquid.

10. The beverage of claim 9, wherein the beverage has a consistent mouthfeel.

11. The beverage of claim 9, wherein the beverage base is selected from the group consisting of water, sodas, coffees, teas, dairy products, sports drinks, meal replacements, and mixtures thereof.

12. The beverage of claim 9, wherein the gelling agent comprises an ingredient selected from the group consisting of proteins, gelatin, pectin, alginate, gums, starches, modified starches, oils, food grade petrochemicals, agars, ε-polylysine, and mixtures thereof.

13. The beverage of claim 9, wherein the flavor additive itself is a homogeneous mixture.

14. The beverage of claim 9, wherein the flavor additive further includes at least one of calcium chloride or a color component.

15. The beverage of claim 9, wherein the flavor additive is configured to be added to a beverage base by a consumer.

16. A multi flavored beverage comprising:
a beverage base;
a first phase including a first flavor profile, the first phase comprising a first flavor additive mixed within the beverage base, the first flavor additive including a flavoring and a gelling agent, the gelling agent comprising 2% by weight or less of the first flavor additive; and
a second phase, distinct from the first phase, the second phase having a second flavor profile, the second phase comprising a second flavor additive mixed within the beverage base, the first phase and the second phase each being one of a liquid suspension, a liquid, or a semi-liquid, the first phase, the second phase, and the beverage base being unable to blend with one another, even upon agitation;
wherein the first flavor profile is perceptably different from the second flavor profile.

17. The multi flavored beverage of claim 16, wherein at least one of the first or second phase comprises a gelling agent including an ingredient selected from the group consisting of proteins, gelatin, pectin, alginate, gums, starches, modified starches, oils, food grade petrochemicals, agars, ε-polylysine, and mixtures thereof.

18. The multi flavored beverage of claim 16, wherein the beverage base is selected from the group consisting of water, sodas, coffees, teas, dairy products, sports drinks, meal replacements, and mixtures thereof.

19. The multi flavored beverage of claim 16, wherein at least one of the first or second phase further comprises at least one of calcium chloride or a color component.
